(19) United States
(12) Patent Application Publication
(10) Pub. No.: US 2009/0078370 A1
(43) Pub. Date: Mar. 26, 2009

(54) Method of separating non-metallic material using microwave radiation

(76) Inventors: Vladislav Sklyarevich, Bensalem, PA (US); Mykhaylo Shevelev, Feasterville, PA (US)

Correspondence Address: Floyd B. Carothers;Carothers and Carothers, 445 Fort Pitt Boulevard, suite 200, Pittsburgh, PA, 15219, US

(21) Appl. No.: 10/584,792

(22) PCT Filed: Jul. 28, 2005
(86) PCT No.: PCT/US05/26739

§ 371 Date: Jun. 27, 2006

(30) Foreign Application Priority Data
Aug. 31, 2004 (US) 60605971

(51) Int. Cl. B29C 71/04

(52) U.S. Cl. 156/344

(57) ABSTRACT

A method of high speed cutting of non-metallic materials (14), preferably glass, is described. In the inventive method a concentrated microwave radiation (1) with appropriate frequency and power density is chosen so as to accomplish heating of at least one selected area (2) of the body at the required separating propagation path (3) to required temperature in a selected short time while ensuring that this temperature is large enough to create a thermal stress (6) through the thickness of the selected area that results in the separating of the body material.

### TECHNICAL FIELD OF THE INVENTION

This invention generally relates to the physical separation of non-metallic materials into a plurality of smaller pieces. In particular, the invention relates to a method for splitting of a glass body.

### BACKGROUND OF THE INVENTION

For manufacturing most products made of glass, semiconductor and other brittle non-metallic material, the separating of work stock into a number of smaller pieces of the desired size or sizes is required. For example, many glass products are formed by a large sheet of glass separated into smaller pieces of the desired size.

There are two main ways to cut glass and similar materials. The first is cutting glass and other brittle substrates that includes abrasion or scribing by the use of mechanical cutting tools. For example, glass sheets have been cut by scribing the glass with a diamond-tipped scribe or a carbide wheel to weaken the molecular structure. After the scribe has been made, physical pressure is applied to create a force at the scribe line to hopefully break the glass along the scribe line.

Another way of splitting bodies of glass and like material into parts is to use the thermal shock process produced by intense local heating of the body. The use of different heat sources for said local heating is known from the art. The most common among them are laser (see, for example U.S. Pat. Nos. 6,420,678; 3,629,545; 4,468,534; 5,609,284), hot gas (5,394,505) or fuel (5,394,505) jets.

Both ways have significant disadvantages. One significant disadvantage is the inability to obtain smooth edges. This may be unacceptable for many products, for example displays or solar panels, because of the required quality of the edge faces. Accordingly, secondary steps such as grinding, edge seaming, and polishing may be performed. However, such secondary steps slow down the manufacturing process, can be expensive and still, very often do not meet the requirements of the edge quality.

Another disadvantage is that edge defects on some of these rough edges may result in crack propagation during further processing or in the ultimate product. The edge strength of the substrate is also reduced. Glass can contaminate the substrate being separated, and require that additional clean-up steps be performed to minimize their impact on the manufacturing process.

The main reason for all these problems is that all known cutting methods from the art create weakness on the surface and then the glass breaks. In the case of using heat, this occurs because all the above-mentioned heat sources heat materials from the surface and do not penetrate inside. As a result, the compressive stress is produced only in the ultra thin heated layer of the surface. This also limits cutting speed. The use of mechanical tools in addition, involves the expenditure of much time and skill, because they are basically manual. Besides, mechanical tools are subject to wear, and worn tools result in inconsistent and unreliable cuts.

Consequently, achieving very smooth cuts on brittle material, especially glass, is a significant challenge in industry. Therefore, there exists the need for a method of dividing or parting substrates of brittle non-metallic material that overcomes these and other problems. The main advantages of a high speed and high quality cutting method are increasing production rate and reducing manufacturing costs.

### SUMMARY OF THE INVENTION

This invention generally relates to the physical separation of bodies of a brittle non-metallic material, preferably glass sheets and pipes, by a thermal shock process in which a microwave radiation is used for rapid and selective heating of a local area of the body. Materials which may be separated by the inventive method include ceramics, semi-conductor wafer materials, glass, fiberglass, quartz, and the like. Material treated by this method can be used in the production of automotive and aircraft glazings, of construction and architectural window glass and the like, of pharmaceutical glass products and the like, of semiconductor wafers and the like, and glass components of various household items and furniture, and the like, structural optical components, and the like, mobile device displays, solar panels, and also in other fields of production and technologies where precision cutting of non-metallic materials is conducted or desirable.

According to the present invention, a method is provided for the separation of bodies of a brittle non-metallic material, preferably glass sheets, by a thermal shock. The inventive method utilizes concentrated microwave radiation to rapidly and selectively heat the local area of the body to be thermally separated (e.g., a glass sheet, a glass pipe).

In the inventive method a concentrated microwave radiation with appropriate frequency and power density is chosen so as to accomplish heating of at least one selected area of the body at the required separating propagation path to the required temperature in a selected short time while insuring that this temperature is large enough to create a thermal stress through the thickness of the selected area which thereby results in the separating of the body material.

The inventive method avoids the use of existing mechanical and thermal tools that are slow and dusty and do not provide a high quality of cut. The present invention includes making the process easily adaptable for many applications, achieving fast cutting speeds and total separation of the substrate, obtaining smooth edges, and eliminating the need for secondary operations. Any kind of brittle material including those having low thermal expansion can be separated by the inventive method.

The main advantages of this high-speed method are the ability to cut a wide range of thicknesses (from super thick, more than 20 mm to ultra thin, less than 1 mm), high quality (dustless, chip and stress-free) and accuracy, reducing manufacturing costs and increasing production rate. Many other specific advantages also exist including but not limited to cutting complex shapes, the elimination of the cost and issues of grinding, transporting and transferring cut parts for grinding, cleaning cuts.

### BRIEF DESCRIPTION OF THE DRAWINGS

FIG. 1 schematically illustrates the temperature profile and compressive stresses that are produced inside a glass sheet when it is irradiated by concentrated microwave radiation.

FIG. 2 schematically illustrates a method for cutting, with simultaneous cooling in accordance with one embodiment of the invention

### DETAILED DESCRIPTION OF THE INVENTION

The present invention relates to a method of thermally separating a brittle non-metallic material, preferably a glass sheet, by a thermal shock. In the inventive method a microwave radiation with appropriate frequency and power density is used.

In all of the embodiments of the invention, the frequency (wavelength) of the concentrated microwave and power density of the applied microwave radiation are important parameters of the inventive method which must be determined for each type of body material and thickness of bodies processed. The process parameters are chosen so as to accomplish heating of selected area of a body at the required separating propagation path to required temperature in a selected time such that the difference in this temperature and the temperature of the rest of the body material is large enough to create a thermal stress that results in the separating of the body material in the heated area. In the inventive method said stress is created not only on the surface but through the thickness as well. Flat, non-flat, and pipe types of bodies can be separated using the inventive method.

These parameters and how they are chosen are generally described below for the embodiment of the invention in which a flat glass sheet is exposed to microwave radiation. However, it is understood that the same parameters and their choices are applicable to and must be considered in the alternative embodiments of the invention: cutting glass pipes, semiconductor materials, and like.

The inventive method is generally applicable to the thermal separation of any type of brittle non-metallic material. These treatments include but are not limited to the glass sheet employed in the production of windshields, side windows, and rear windows for vehicles such as automobiles and the like, the production of architectural window glass and related materials, the production of pharmaceutical glass products such as vials, ampoules, pipettes, and the like, display glass for mobile devices, solar panels, and the like, glass components of various household items and furniture, and the like, fiberglass and the like, as well as, semiconductor materials employed in the production of semiconductor wafers and the like.

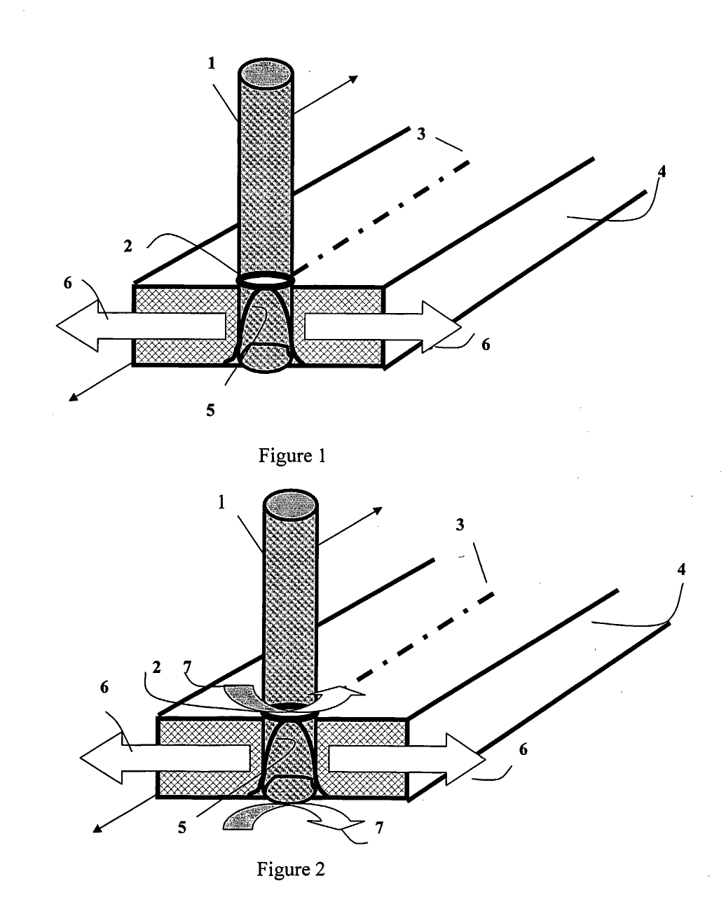

The cutting of glass, under the action of thermal stresses, consists of the following. When concentrated microwave radiation (microwave beam) 1 (see FIG. 1) is applied to a selected area 2 at the required separating propagation path 3 of the glass sheet 4, the concentrated microwave radiation 1 passes through the glass sheet and heats the area throughout the depth. Curve 5 illustrates the temperature profile inside the glass sheet 4 that is created by this heating. Compressive stresses 6 are produced in the material being heated because the surrounding areas remain under lower temperature, as well as, surface temperature reduction just after heating under cooling by cold ambient air. The splitting of the plate glass occurs when these thermally-induced stresses exceed glass tensile strength.

While the tensile strength is determined primarily by the characteristics of the glass being processed, the compressive stresses can be increased because they mainly depend on the volume of the glass that is heated up, and the temperature gradients in and around the heated area. The rate of thermal splitting (cutting speed) in turn is dependent on how rapidly appropriate compressive stresses are created. All this means that the selected area should be heated throughout the thickness and it should be heated rapidly and to a high enough temperature. These conditions can be satisfied by the selection of effective microwave frequency and sufficient power density.

The particular frequency chosen should ensure the heating of the selected glass sheet area throughout the thickness of the glass sheet with maximum coupling of the incident microwave energy in the area. In addition, the chosen frequency should be cost effective and microwave generators for the selected frequency should be readily available at the required power.

We found that the frequency range of microwave energy that meets these requirements for most actual thicknesses and material properties where the inventive method can be applied is in the gigahertz range. However, the necessary power density drastically rises if the microwave frequency is lower than 10 GHz, and creates many technical and economic problems. Therefore a higher microwave frequency is more preferable. On the other side, the current state-of-the-art level of microwave technique makes it very difficult and expensive to install a power system with a frequency higher than 1000 GHz. Thus, the effective microwave frequency range for the present invention is between about 10 GHz and about 1000 GHz. The preferable frequency is such that the skin layer for this frequency in the body material approximately equals its thickness. In this case, heating across the thickness is guarantied.

In the embodiments of the invention discussed above, a microwave absorbent, having a greater microwave absorption than the body material at a selected microwave irradiation frequency, is applied along the required separating propagation path. This allows increasing the cutting speed and accuracy because higher absorption increases the heating rate.

Heating rate increases more if microwave irradiation frequency is selected such that the skin layer for this frequency in the absorbent approximately equals its thickness. The absorbent is selected from the group consisting of semi-metals, carbides, nitrides, oxides, sulfides, silicides, boron, carbon, graphite and metals.

Cutting speed increases also if selected heated area and its surrounds of the body of material are cooled during exposure to microwave, as well as, before and after exposure, because this increases compressive stresses. A stream of cold gas 7 (see FIG. 2), for example, liquid nitrogen steam that blows on the body, can be used for said cooling because gases are transparent to microwave. The body can be cooled by placing it on a cooled metal support and/or by placing a cold correspondently shaped plate on the surface that is exposed to microwave. The material of said plate is transparent to microwave and is selected from the group consisting of oxide ceramics, nitride ceramics, quartz and diamond.

Accuracy and cutting speed can be increased if the exposure to concentrated microwave radiation is conducted through a metal mask with an opening along the required propagation path.

It has been further found that maximal speed can be achieved by irradiating applied absorbent and/or irradiating through the mask, all at once.

Making a short scribing just at the edge on the glass surface makes the glass parting start more easily and more accurately, without losing the quality of cutting.

Concentrated microwave radiation with the necessary frequency and power density can be achieved using generators such as the gyrotron, klystron, traveling wave tube, and backward wave oscillator, and the like.

The main distinctions of the inventive method are high cutting speed, quality of cut, and range of thicknesses that can be cut, as well as, eliminating the need for secondary operations. Any kind of brittle material including those having low thermal expansion can be separated by the inventive method.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A method of separating a body of brittle non-metallic material by thermal shock comprising: exposing the body to concentrated microwave radiation of an effective frequency and sufficient power density to heat at least one selected area of the body at a required separating propagation path to a required temperature in a selected time whereby the selected power density, and exposure time are sufficient to ensure that the selected area is heated to said temperature which is higher than the rest of the body material temperature such that the difference in said temperatures is large enough to create a thermal stress through the thickness of the selected area that results in the separating of the body material.

2. The method in accordance with claim 1 wherein the microwave irradiation frequency is between about 10 GHz to about 1000 GHz.

3. The method in accordance with claim 1 wherein the preferable microwave irradiation frequency is selected such that the skin layer for this frequency in the body material is approximately equal to its thickness.

4. The method in accordance with claim 1 wherein the selected heated area and its surrounds of the body of material are cooled during, and optionally prior and after, exposure to microwave.

5. The method in accordance with claim 4 wherein cold gas is blown on and around the body.

6. The method in accordance with claim 4 wherein the body is placed on a cold metal.

7. The method in accordance with claim 4 wherein the microwave is exposed through a cold, and transparent to microwave, material that is lying upon the body's irradiated surface.

8. The method in accordance with claim 7 wherein the transparent material is selected from the group consisting of oxide ceramics, nitride ceramics, quartz and diamond.

9. The method in accordance with claims 1 wherein the exposure to microwave radiation is carried out through a metal mask with an opening along the required propagation path.

10. The method in accordance with claim 9 wherein the required propagation path is exposed to microwave all at once.

11. The method in accordance with claim 1 wherein a surface of the body is scribed at an edge area of the propagation path.

12. The method in accordance with claim 1 wherein the source of microwave radiation is selected from the group consisting of gyrotron, klystron, magnetron, traveling wave tube, and backward wave oscillator.

13. The method in accordance with claim 1 wherein a microwave absorbent having a greater microwave absorption than the body material at a selected microwave irradiation frequency is applied along the required separating propagation path.

14. The method in accordance with claim 13 wherein the microwave absorbent is selected from the group consisting of semi-metals, carbides, nitrides, oxides, sulfides, silicides, boron, carbon, graphite and metals.

15. The method in accordance with claim 13 wherein the microwave irradiation frequency is selected such that the skin layer for this frequency in the absorbent is approximately equal to its thickness.

16. The method in accordance with claim 13 wherein the entire applied absorbent is exposed to microwave all at once.

17. The method in accordance with claim 13 wherein the selected heated area and its surrounds of the body of material are cooled during, and optionally prior and after, exposure to microwave.

18. The method in accordance with claim 13, wherein the exposure to microwave radiation is carried out through a metal mask with an opening along the required propagation path.

19. The method in accordance with claim 13 wherein a surface of the body is scribed at an edge area of the propagation path.

20. The method in accordance with claim 13 wherein the source of microwave radiation is selected from the group consisting of gyrotron, klystron, magnetron, traveling wave tube, and backward wave oscillator.
